(19) United States
(12) Patent Application Publication
(10) Pub. No.: US 2018/0104159 A1
(43) Pub. Date: Apr. 19, 2018

(54) Pacifier

(71) Applicants: Michael K. Bredemeier, Dunedin, FL (US); Lori A. Bredemeier, Dunedin, FL (US)

(72) Inventors: Michael K. Bredemeier, Dunedin, FL (US); Lori A. Bredemeier, Dunedin, FL (US)

(21) Appl. No.: 15/785,961

(22) Filed: Oct. 17, 2017

Related U.S. Application Data
(60) Provisional application No. 62/408,996, filed on Oct. 17, 2016.

(51) Int. Cl. A61J 17/00; B29C 43/20; B29C 43/42; B29C 43/00

(52) U.S. Cl. CPC A61J 17/008; B29C 43/203; B29K 2083/00; B29C 43/003; B29C 43/42

(57) ABSTRACT

A pacifier and a method of making a pacifier. Two or more separate silicone-based materials are joined together with a compression mold such that the pacifier defines a unitary structure where gaps and related crevices associated with multi-piece pacifier construction are avoided while still permitting artwork, differing colors or other aesthetically-pleasing indicia. In one form, one grade of silicon may be utilized in a region of the pacifier that is placed within a baby's or child's mouth, while another grade of silicone material may be used in a region of the pacifier that is not normally associated with placement within a baby's or child's mouth. The aesthetically-pleasing indicia that is formed in or on the pacifier is achieved without recourse to painting, labels, appliques, embossing, decals, stickers or other affixable or markable medium.

This application claims the benefit of U.S. Provisional Application Ser. No. 62/408,996, filed Oct. 17, 2016.

### BACKGROUND

The present disclosure relates to a child's pacifier, and more particularly to a pacifier defining a unitary construction made of two different silicone-based materials.

Known children's pacifiers come in two general forms: (1) a multi-piece construction made from one or more components that define a combination nipple and mouth-guard, and a component that defines a pivoting or swiveling ring-shaped handle; and (2) a one-piece (i.e., unitary) construction where the handle is integrally molded with the nipple and mouth-guard. The first form accounts for a vast majority of the pacifiers sold in the retail market, and is commercially popular because of its ability to cost-effectively incorporate different designs that make them aesthetically appealing. Despite this, multi-piece construction tends to be expensive, as any painted-on or printed features—the latter in the form of labels, appliques, embossing, decals, stickers or other affixable medium—that are used to introduce writing, marking or other fanciful indicia can easily scratch, fade or rub off into a baby's mouth. Attempts at avoiding such a situation involves the extra expense of covering the fanciful indicia with a clear overlayer (such as through overmolding or the like), and can tend to obfuscate other potentially valuable features such as three-dimensional shaping or textures. Even more significantly, such multi-piece construction may not be sufficiently hygienic, as gaps, cracks or related discontinuities at locations where various portions of the pacifier are joined can collect dirt, water, bacteria or the like over periods of repeated use.

The second form is what is typically given to newborns in the hospital during their stay there; this form is almost invariably made from a silicone-based material. While such one-piece form tends to have improved hygienic properties relative to the multi-piece variant, its material choice and method of making leaves little or no ability to provide aesthetically-pleasing design affectations. Moreover, while overmolding and related processes can provide some measure of design flexibility, they still suffer from difficulties associated with trying to form two or more dissimilar materials into a unitary (i.e., one-piece) finished structure. For example, overmolding necessitates the use of excess material such that at least some will be wasted. Moreover, overmolding always relies on liquid injection over a previously-formed solid original part that is held in place so that the injected fills the voids of the mold around the original part, which necessitates a multi-step process (such as through two-shot injection molding or the like). Furthermore, because the surface area of a pacifier is relatively small, it is difficult to mold multiple colors or related design affectations onto the surface of the surface of the pacifier. In addition, even if introducing design features were possible, the additional passes required would necessitate the use of sophisticated equipment and concomitantly higher production expense.

The author of the present disclosure is not aware of an attempt to combine the material and aesthetic benefits that arise out of multi-piece construction with the hygienic and cost benefits of one-piece construction for a child's pacifier, and as such believes that it would be desirable to create such a pacifier, as well as a way of making the same.

### SUMMARY

According to one embodiment, a pacifier is disclosed. The pacifier includes a shield portion and a nipple portion where the two portions are integrally formed with one another. The shield portion and the nipple portion are made from one or both of a different grade of silicone or a different color of silicone. In addition, the shield portion and the nipple portion are devoid of any printed indicia such that no painting, labels, appliques, embossing, decals, stickers or other affixable or markable medium appear on or in the pacifier.

According to another embodiment, a method of making pacifier is disclosed. The method includes introducing a first silicone material into a compression mold that is shaped to define the pacifier with at least a shield portion and a nipple portion, introducing a second silicone material into the compression mold platen such that the first and second silicone materials are made from at least one of a different grade of silicone or a different color of silicone. After the silicone materials have been introduced, they are compressed (and in one form, heated) within the mold such that the nipple portion is integrally formed with the shield portion. In addition, both the shield portion and the nipple portion are devoid of any printed indicia.

According to yet another embodiment, a pacifier with a shield portion and a nipple portion that define a one-piece unitary structure made by a compression molding method is disclosed. The method used to produce the pacifier includes using a compression mold to define cavities formed in the surface thereof that substantially equate to an exterior shape of the pacifier. First and second silicone materials are introduced into the compression mold such that the second silicone material is made from at least one of a different grade of silicone or a different color of silicone from that of the first silicone material. The compression mold is then used to compress the first and second silicone materials such that the nipple portion is integrally formed with the shield portion. The resulting pacifier is configured such that both the nipple portion and the shield portion are devoid of any painting, labels, appliques, embossing, decals, stickers or other affixable or markable printed indicia.

### BRIEF DESCRIPTION OF THE SEVERAL VIEWS OF THE DRAWINGS

The following detailed description can be best understood when read in conjunction with the following drawings, where like structure is indicated with like reference numerals and in which:

FIG. 1 shows a front elevation view of a conventional multi-piece pacifier according to the prior art;

FIG. 2 shows a perspective view of a conventional one-piece pacifier according to the prior art;

FIG. 3 shows a side elevation view of a pacifier according to the present disclosure highlighting the use of different materials for different portions or regions within the pacifier;

FIG. 4A shows an exploded perspective view of an embodiment of the pacifier of FIG. 3, this time highlighting the use of fanciful artwork and shaping;

FIG. 4B shows a perspective view of another embodiment of the pacifier of FIG. 3 with the use of different fanciful artwork and shaping;

FIG. 4C shows a perspective view of yet another embodiment of the pacifier of FIG. 3 with the use of different fanciful artwork and shaping;

FIG. 5 shows a simplified view of a compression mold apparatus that may be used to form the pacifier of FIGS. 3, 4A, 4B and 4C; and

FIG. 6 shows a flowchart with process steps used to make the pacifier of the present disclosure.

### DETAILED DESCRIPTION

Embodiments described herein relate to pacifiers that form a unitary structure from one or both of multiple grades or multiple colors of silicone material. In one form, a food-grade (also referred to herein as an FDA-grade) silicone is used for at least some of the pacifier, while a medical-grade silicone is used for the rest. In addition, compression molding may be used so that one of the grades or colors of silicone may first be placed within the mold while in a generally solid or putty-like form, while the other of the grades or colors of silicone is introduced as a solid, putty, gel or related viscoelastic material. By providing one or both of three-dimensional and multicolor features into a one-piece structure, the pacifier can provide aesthetically-pleasing design affectations while avoiding the cost, complexity or impermanence of paint, printed labels or related topical or interstitial approaches. In one form, the use of surface shaping (such as that imparted to the outer surface of the pacifier from the mold) can add texture and shading—either with or without the inclusion of multiple colors—to the exposed outer surface of the pacifier without the need for such paint, printed labels or overmolding the last of which includes the partial or complete encapsulation or surrounding of one portion of a pacifier by another portion. In a similar way, the pacifier according to the present disclosure avoids any molding technique (such as injection molding, liquid injection molding or the like) that involves a silicone or other moldable material (such as a thermoplastic material) that is used to effect such encapsulation or surrounding.

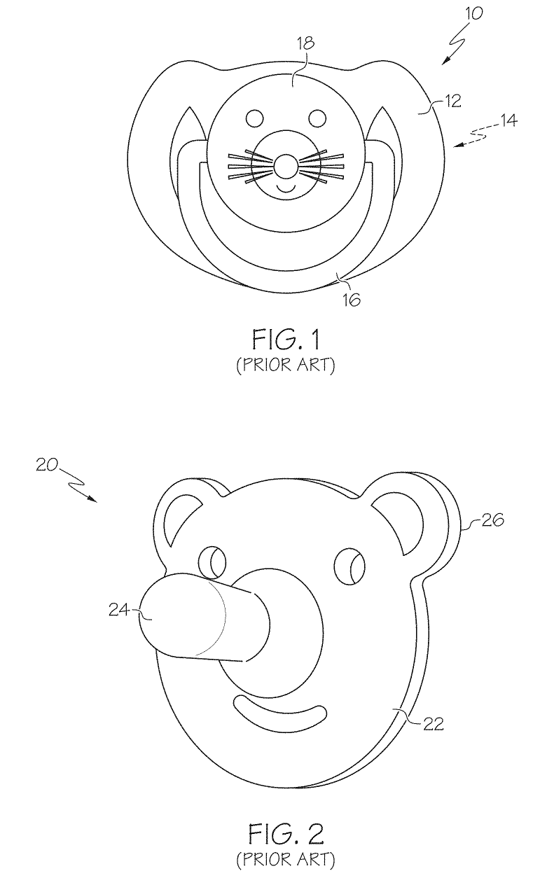

Referring initially to FIGS. 1 and 2, the major components of a pacifier 10, 20 according to the prior art are shown for both a multi-piece construction (FIG. 1) and a one-piece construction (FIG. 2). In either case, such pacifiers 10, 20 typically include a mouthguard-like shield 12, 22, a nipple 14, 24 and a handle 16, 26; in the case of the multi-piece construction of FIG. 1, a central cap 18 is also shown, whereas with the one-piece construction of FIG. 2, a hole (not shown) opens into the longitudinal void of the nipple 24. As is shown with particularity in FIG. 1, the multi-piece construction is in the form of an assembly made from various discreet components where the central cap 18 (and in other cases the same method of design is used on the shield 12) may include artwork or other fanciful image embossed, printed or otherwise formed thereon, while the one-piece construction of FIG. 2 is a single, unitary component. It will be appreciated that in situations where the pacifiers 10, 20 are made of flexible material, the shield 12, 22 must be of a minimum dimension to meet gage test standards, while also possessing ventilation apertures; these and other standards are discussed in Consumer Product Safety Commission (CPSC) Regulation 16 CFR 1511. As can be understood from FIG. 1, the multi-piece pacifier 10 results in the formation of pivot points, disconnects and open internal volumes associated with the joined portions such that numerous gaps and crevices are formed that can collect dirt, as well as saliva, water or other liquids that can facilitate the growth of bacteria or other harmful agents. Contrarily, while the unitary construction of the one-piece pacifier 20 generally avoids the formation of features where excess dirt or fluids may collect, its choice of a single material limits its ability to create small components, as well as those where aesthetic or fanciful embellishments are desired.

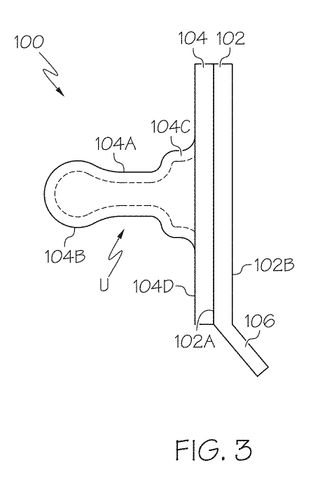

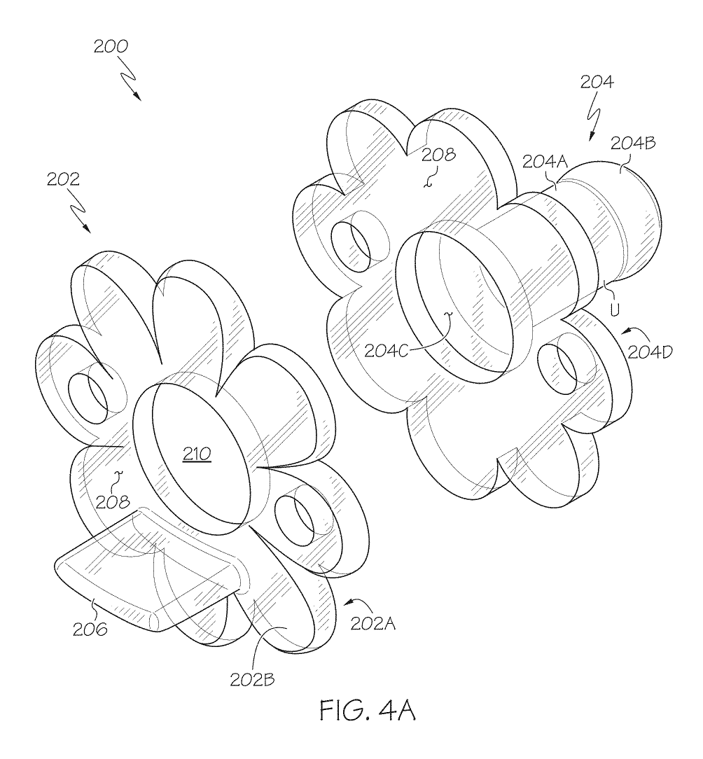

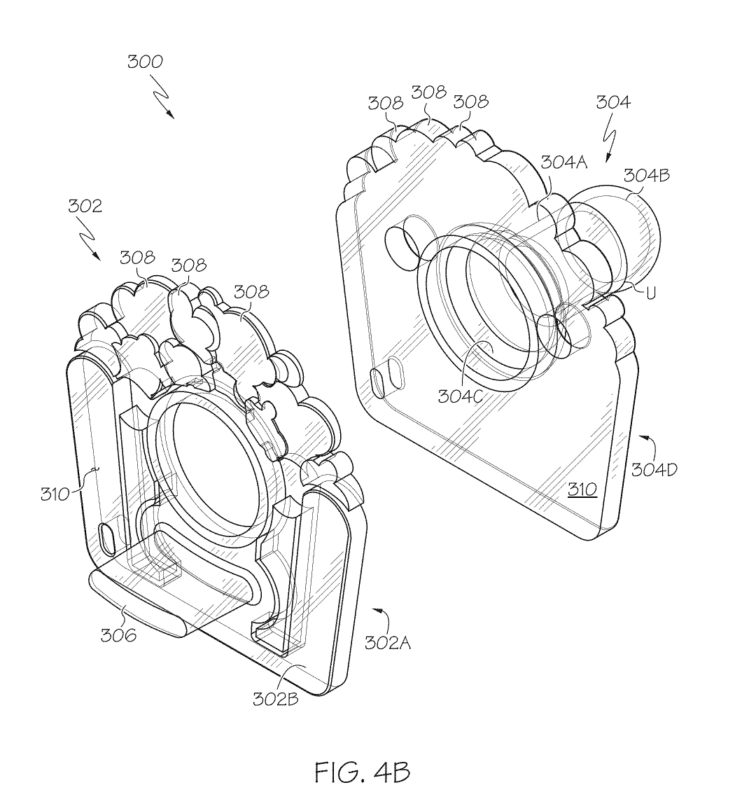

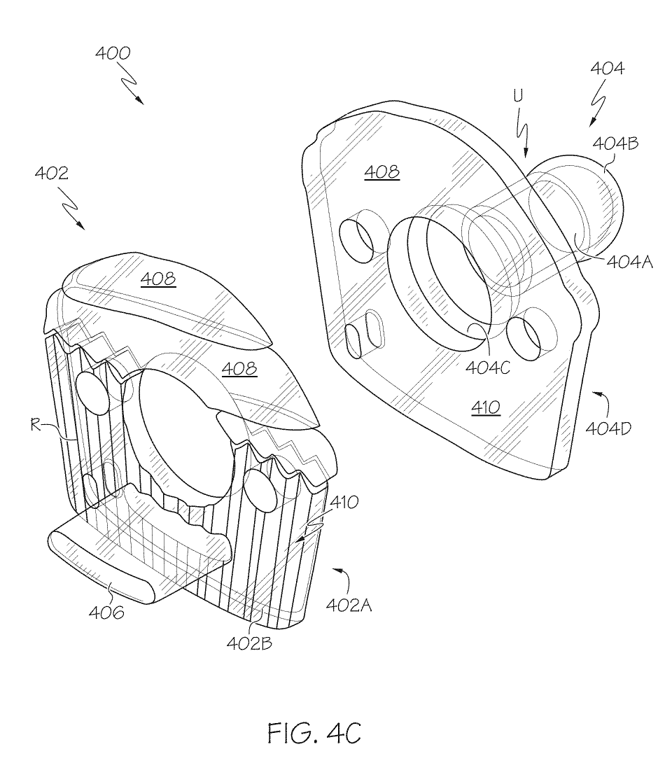

Referring next to FIGS. 3 and 4A through 4C, examples of a pacifier 100 in its as-formed condition is shown, as are various exploded-views of pacifiers 200, 300 and 400 that include various shapes, including a daisy-shaped, box of popcorn-shaped and cupcake-shaped variants. It will be appreciated that the presently-shown fanciful designs are meant to be representative rather than exhaustive, and that other fanciful designs may be formed, and that all such designs are deemed to be within the scope of the present disclosure. As such, most of the discussion pertains to a pacifier in generalized terms such as that identified in conjunction with the pacifier 100 of FIG. 3, although any discussion pertaining to one of the particular embodiments of FIGS. 4A, 4B and 4C will be identified as those of the daisy-shaped, box of popcorn-shaped and cupcake-shaped variants, respectively. Moreover, such a discussion of a generalized or particular pacifier will be apparent from the context, it being understood that the various portions and features associated with the generalized pacifier 100 that are common with the particular embodiments of FIGS. 4A through 4C apply to each of those embodiments mutatis mutandis.

Referring with particularity to FIG. 3, in one form, the pacifier 100 includes a shield portion 102 with first and second opposing surfaces 102A and 102B, and a nipple portion 104 that in one form includes a bulbous or otherwise enlarged distal end 104B formed on a generally cylindrical-shaped shaft 104A that extends in a cantilevered manner from a proximal end 104C that is integral with a base 104D that forms a facingly adjacent common surface against the first opposing surface 102A. In another form, other shapes (not shown) of the distal end 104B may be included in order to make the pacifier 100 more orthodontically suitable for use by babies and small children. While the first opposing surface 102A is disposed to be facingly adjacent the base 104D of the nipple portion 104, the second opposing surface 102B faces away in an outward direction from a baby's face when the pacifier 100 is in use. The nipple portion 104 forms the region of pacifier 100 that experiences the most contact with the child's mouth, and in one form may be made from a medical-grade silicone. Such a material choice is particularly beneficial for its particular hydrophobicity, low surface tension and chemical and thermal stability properties that in turn lead to biocompatibility and biodurability that comport with higher standards (such as those discussed above by the CPSC) for certain end-use applications. Likewise, a more conventional food grade (or related) silicone may be used for the shield portion 102 in general and in particular for the second surface 102B that faces away from the child's mouth. Similar shield portions 202, 302 and 402 respectively—as well as their corresponding first and second opposing surfaces 202A and 202B, 302A and 302B and 402A and 402B—along with nipple portions 204, 304 and 404 and their respective shafts 204A, 304A and 404A, enlarged distal ends 204B, 304B and 404B, proximal ends 204C, 304C and 404C and bases 204D, 304D and 404D are likewise shown in their respective FIGS. 4A through 4C. In addition, an integrally-formed handle 106, 206, 306 and 406 may extend away from the respective shield portions 102, 202, 302 and 402 on their second opposing surfaces 102B, 202B, 302B and 402B.

In another form, the nipple portion 104 may be made such that the distal end 104B, shaft 104A and proximal end 104C are formed from a separate silicone material from the base 104D. In such form, the base 104D tends to more closely resemble the shield portion 102 in general and the first opposing surface 102A in particular. For example, the shape, size and material choice may be made such that the distinction between the base 104D and the first opposing surface 102A becomes evanescent such that the two define the same piece of structure. It will be appreciated that both forms are within the scope of the present disclosure. Regardless of whether the base 104D is made separately from the distal end 104B, shaft 104A and proximal end 104C, in one form the base 104D is still made from medical grade silicone as it is designed to be in substantially constant contact with a baby's face, lips or nose.

Also within the present context, the shield portion 102 and the nipple portion 104 are deemed to be integrally formed with one another when upon molding the resulting pacifier 100 defines the unitary (that is to say, one-piece) structure. Contrarily, devices that comprise separately-formed or separately-attachable components (such as handles, rings or the like) are deemed to not be integrally formed. Thus, rather than mimicking a laminated structure (such as that associated with a composite-like structure of disparate materials), the joining (such as by compression molding, as discussed in more detail below) of the two surfaces 102A, 102B or the two portions 102, 104 to one another tends to form the pacifiers 100, 200, 300 and 400 as a unitary construction through the chemical bonding of two or more silicone-based materials, as discussed in more detail below. Moreover, the properties of two different grades or colors of silicone material can be tailored to particular needs, based on (for example) strength, modulus of elasticity, hygienic properties, ease of manufacturability or the like. Accordingly, the inclusion of two separate grades or colors of the same material differs from a conventional laminate in that the former still results in a single unitary structure with a chemical bond is formed that provides a robust, continuous transition from one of the silicone materials to the other that is more than a mere mechanical joining. In one form, silicone is beneficial in that unlike other materials (such as thermoplastic elastomers), there is a substantial absence of detectable odors. In addition, by avoiding the use of an overmolding-based process where a mere multi-layered mechanical lock or related encapsulation is formed between the joined components, the process disclosed herein may be used to produce a truly integral, unitary finished structure for pacifier 100 that can simultaneously achieve enhanced levels of aesthetic, cost and cleanliness objectives.

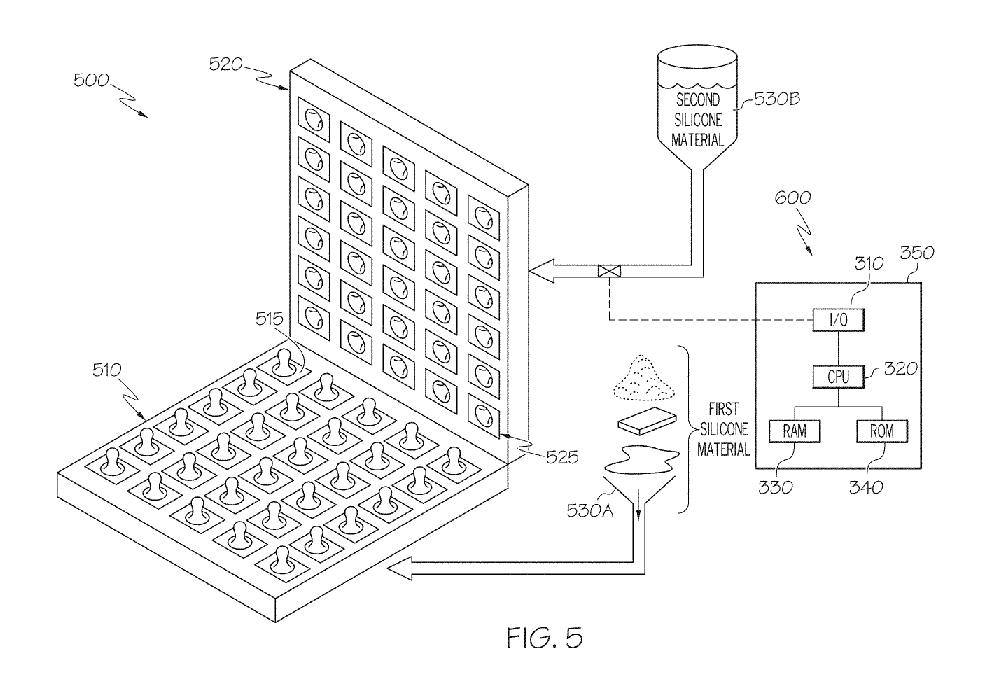

In one form, a first silicone material that is introduced into the mold (such as the compression mold 500 that is discussed in more detail in FIG. 5) may form a substrate (for example, the base 104D of the nipple portion 104) along with the rest of the nipple portion 104 such that a second silicone material that is subsequently introduced into the mold may fill out a remainder of the shape defined by the pacifier 100 which may in one form include one or the both of the first opposing surface 102A and the second opposing surface 102B, and may optionally include the handle 106. In one form, this second silicone material that makes up such remainder may be made from the previously-discussed food-grade silicone. Significantly, by using two similar materials with differing grades (such as food-grade and medical-grade silicone as discussed previously) or colors, adequate chemical bonding (such as through relatively strong covalent bonding) can be achieved, which contributes to the unitary construction of the completed pacifier 100.

As can be seen, the outer surface or contour of the pacifier 100 is devoid of printed indicia. Moreover, any interfacial region (such as that defined by where the first and second opposing surfaces 102A, 102B of the shield portion 102 are joined) is also devoid of printed indicia. Within the present context, the term “devoid of printed indicia” means that the relevant portion 102, 104 of pacifier 100 includes no separate painting, label, applique, embossing, decal, sticker or other writing, images, marking or related design affectation. Such term does not include any such writing or fanciful image that results from—or is an inherent part of—surface features that at least partially define the three-dimensional shape of pacifier 100. As such, one or more of raised lettering or fanciful images that result from shapes that are imparted to the pacifier 100 from the mold may be included in or on the pacifier 100 and still be consistent with the stricture against printed indicia.

In one form, undercuts may be included in the design of the pacifier 100. For example, it can be seen from each of FIGS. 3 and 4A through 4C that the bulbous or otherwise exaggerated distal ends 204B, 304B and 404B result in an undercut U beneath the nipple portion 104. Within the present context, undercut U is that portion of a molded component (such as pacifier 100) that would ordinarily prevent the withdrawal of the component from a one-piece mold from which the component is formed. For example, an undercut on a conventional molded part that is formed in an injection molding or other apparatus would prevent that part from being directly ejected from the mold. While ordinarily such an undercut would necessitate the use of an insert or related separately movable part, the high elongation values (sometimes in excess of 500% or more) of the silicone materials contemplated for use for pacifiers 100, 200, 300 and 400 permits a better tolerance to a significant amount of stretching around a corresponding part of the mold 500 that is shaped to provide such undercut region without the tendency to tear or otherwise damage the pacifier 100 that would accompany the use of a conventional thermoplastic or thermosetting material. This is valuable for portions of the pacifier 100 that would otherwise require the use of inserts in order to accommodate such undercuts.

In one form, both silicone materials making up the shield portion 102 and the nipple portion 104 are substantially the same in terms of base material such that similar properties (such as durometer hardness, elongation, tear strength, tensile strength or the like) and ability to achieve a strong bond are preserved, while the different colors or grades (the latter of which may be in the form of the medical-grade food-grade variants discussed elsewhere in this disclosure) may be used to achieve certain aesthetic or design objectives. Although it is preferable that the respective shield and nipple portions 102 and 104 may be made of two different grades or colors of silicone materials each taking advantage of known properties, it will be appreciated that in an alternate embodiment various regions (such as the first opposing surface 102A of shield portion 102 and the base 104D of the nipple portion 104) may be made from the same material. As such, both could be made from a food-grade silicone, a medical-grade silicone or a combination of both, as well as from similar or dissimilar colors.

Significantly, the pacifier 100 embodies the design flexibility of the multi-piece pacifier 10 and the hygienic features of the one-piece pacifier 20 through a suitable molding process such that a single, integral structure is formed. For example, the handles 106, 206, 306 and 406 may be made from a food-grade silicone along with the second opposing surface 102B of the shield portion 102 that can accept colors, patterns or other decorative indicia thereon, while the nipple portion 104 and shield portion 102 may be made from the aforementioned medical-grade silicone. In one form, the handles 106, 206, 306 and 406 may be tab-shaped, while in another they are ring-shaped, and that these and other forms are deemed to be within the scope of the present disclosure. As shown with particularity in FIG. 3, the handle 106 is preferably coupled to the second surface 102B of the shield portion 102 such that it at extends away from the second surface 102B in order to promote gripping. In one form, such an extension can be configured such that the coupling defines a cantilevered structure. Likewise, the handle 106, 206, 306 and 406 may include shaping (such as a ring, periodically-spaced bumps or protrusions (none of which are shown) in order to enhance grippability.

The integral construction of pacifier 100 is such that when a baby or child applies a sucking force to the nipple portion 104, a certain amount of flexing of the attached shield portion 102 may be expected to take place; such flexing is permissible as long as the connection between the shield portion 102 and nipple portion 104 remains intact. As mentioned above, through a proper choice of materials, the dimensions of the pacifier 100 may be adjusted to ensure such intactness, depending on the need and configuration. By way of example, the shield portion 102 may be made smaller for a baby than for a child. Likewise, tactile adjustments may be made through material choice, where regions within the pacifier 100 may be made selectively soft to the touch.

Referring with particularity to FIGS. 4A through 4C, the daisy-shaped pacifier 200 of FIG. 4A includes depth and shadows to mimic actual daisy petals 208 and center 210 (in configurations where such center may define a solid layer of silicone material rather than an opening such as that used to provide an air passageway to the nipple portion 204). Likewise, the popcorn-shaped pacifier 300 of FIG. 4B has raised and lowered parts to mimic the puffed texture of individual popped kernels 308, while the region corresponding to the box 310 may or may not include simulated creases, ridges, angles or other shapes that may provide altered transmission of light or color through the corresponding surface. In a similar manner, the icing of the cupcake-shaped pacifier 400 of FIG. 4C mimics the layered ridges of actual icing 408 with its curved peaks and valleys that are associated with a swirled deposition or forming of such icing 408 on top of the cake 410 that may include ridges R, creases or the like in order to similarly change light transmission. These three-dimensional attributes—as well as varying colors (either together or independently of one another) help provide an enhanced aesthetic and realistic appeal in a manner that analogizes the difference between a sculpture and a picture.

Referring next to FIG. 5, the pacifier 100 may be produced by a compression mold 500 such as that shown in simplified form. In one form of compression mold 500, two waffle iron-like platens 510, 520 with one or more volumetric surface cavities 515, 525 are alignable and joinable (such as through a hinged pivot) to one another such that the moldable precursor silicone materials may be introduced into the cavities 515, 525. In this way, upon the subsequent closure and application of heat, the two forms of silicone material may cure into the hardened pacifier 100 with a shape defined by the cavity. It will be appreciated that identification within the present disclosure of one or the other of the first and second platens 510, 520 is merely for convenience, and that it will be understood that identifying either the first or second of the platens 510, 520 to define volumetric space associated with the cavities 515, 525 therein that are shaped to substantially conform to one or the other of the shield and nipple portions 102, 104 will be context-dependent, and that both such forms are within the scope of the present disclosure.

Such a process is augmented within the context of the present disclosure in that the first and second silicone materials may be introduced via silicone dispensers 530A, 530B that may be placed in communication with the platens 510, 520 such that differing colors or material grades may be added to precise locations within the one or more surface cavities 515, 525. Regardless of whether the precursor silicone material is delivered to the mold 500 in solid (which may include granular precursors), putty, gelatinous or viscoelastic form, such addition is significant for the production of pacifier 100 in that it permits the inclusion of aesthetically-pleasing affectations or embellishments to be included on the second surface 102B of the shield portion 102 while still preserving the biocompatible features of the medical grade silicone that is used on the first surface 102A and the nipple portion 104. This would help overcome the negative perception traditionally associated with the use of pure forms of medical grade silicone where once colors, dyes or related pigments are added to the silicone, it is no longer deemed to be preferable to be used in such applications—including those associated with the nipple portion 104 or the shield portion 102—that call for the use of such medical grade silicone. Likewise, because it is permissible to include artwork produced from color or shape selections to food grade and other so-called lower grades of silicone, differing colors, fanciful images or a combination of both may be added to—by way of example—the second surface 102B of shield portion 102. As can be seen, in situations where the first silicone material is being introduced in solid, putty or other substantially non-liquid form, the silicone dispenser 530A may instead be a hand-placement, layup or other placement of the first silicone material into one or the other of the cavities 515, 525.

In one form, the use of compression mold 500 (and its two-part mold or platen structure) along with the choice of silicone as the flexible elastomeric material permits the pacifier 100 to be formed with at least a limited amount of undercuts U. In this way, the fabrication of the pacifier 100 can be achieved without resorting to more complicated mold tooling (in particular, inserts and related four-part mold equipment such as discussed previously) and the associated additional manufacturing steps. As discussed previously in conjunction with FIG. 3, the nipple portion 104 may define a bulbous projection at its distal end 104B such that it is wider than its proximal end 104B. While such a bulbous or related larger lateral profile produces an undercut U in the compression mold 500 of FIG. 5, it is small enough that the high elongation values of silicone (often greater than 500% or more) make it relatively easy to remove the completed pacifier 100 from the mold 500 without causing damage to the nipple portion 104 and the bulbous projection at its distal end 104B. In another form (not shown), the distal end 104B may be flared or tapered relative to the proximal end 104C, including linear (i.e., straight) tapers, parabolic tapers or the like, and that all such variants and the relatively modest undercuts they produce are deemed to be within the scope of the present disclosure.

A significant benefit to compression molding is that all of the features of the pacifier 100—including both its utilitarian and fanciful attributes such as those associated with the particular embodiments of the daisy-shaped pacifier 200, box of popcorn-shaped pacifier 300 and cupcake-shaped pacifier 400—can be achieved in a single (that is to say, one-step) placement of all colors and shapes within the volumetric surface cavities 515, 525 that are defined within the platens 510, 520. By using compression molding, the pacifier 100 can take advantage of one-step (or single-step) formation such that the silicone is placed, injected or otherwise inserted into the platens 510 520 of the mold 500 then molded together in a single molding operation instead of a multi-step approach such as that employed in a conventional two-shot, multi-shot or related overmolding process.

In one form, the cavities 515, 525 that are formed in the compression mold 500 may be used so that one of the grades or colors of silicone is compartmentalized in one of the mold platens 510, 520, while the other of the grades or colors of silicone is introduced either into the other of the mold platens 510, 520, or into a closed volume defined between the two platens 510, 520. In this way, at least a port of the silicone material used to fill the cavities 515, 525 of the mold platens 510, 520 that are formed in the compression mold 500 may be used so that one of the grades or colors of silicone is compartmentalized in one of the mold platens 510, 520 may be in solid or putty-like form, which may include granules, putty-like masses, or other solid preforms. In another form, the silicone material used to fill both of the cavities 515, 525 may be in solid or putty-like form. Having at least some of the fill be made from solid or putty-like consistency allows more precise placement of the silicone into the mold 500, which in turn allows for ease of color customization of the as-produced pacifier 100 without having to resort to a multi-step injection or other repeated process. In addition, a gelatinous or related viscoelastic material may be used to fill a part of the mold cavities 515, 525, while at least some of the mold cavity portions are filled with silicone in putty or solid form. Within the present context, it will be understood that a viscoelastic material may be used in either or both of the cavities 515, 525 so long as the material is compatible with the single-step compression and heating, as well as the desired degree of solidity or flowability needed to achieve the desired customization of colors, three-dimensional outer surface profile or the like.

In one form, the compression mold 500 may have automated operation through controller 600 that includes one or more input/output (I/O) 610, microprocessor (CPU) 620, read-only memory (ROM) 630, random-access memory (RAM) 640, which are respectively connected by a bus to provide connectivity for a logic circuit 650 for the receipt of signal-based data, as well as the sending of commands or related instructions. Various algorithms and related control logic may be stored in the ROM 630 or RAM 640 in manners known to those skilled in the art. The control logic may be embodied in an algorithm or related program code that can be manipulated or otherwise operated on by CPU 620 and then conveyed via I/O ports 610 to one or both of the silicone dispensers 530A, 530B. In one form, the ROM 630 is used for storing a program which controls the operation of the overall apparatus, while RAM 640 is used for storing data. Likewise, CPU 620 may be implemented as a general purpose processor, a content addressable memory, a digital signal processor, an application specific integrated circuit, a field programmable gate array, any suitable programmable logic device, discrete gate or transistor logic, discrete hardware components, or any combination thereof. It will be appreciated by those skilled in the art that the algorithm or related control logic is a series of specific steps for performing a function, and as such forms a functional description of a software program to give it structural attributes.

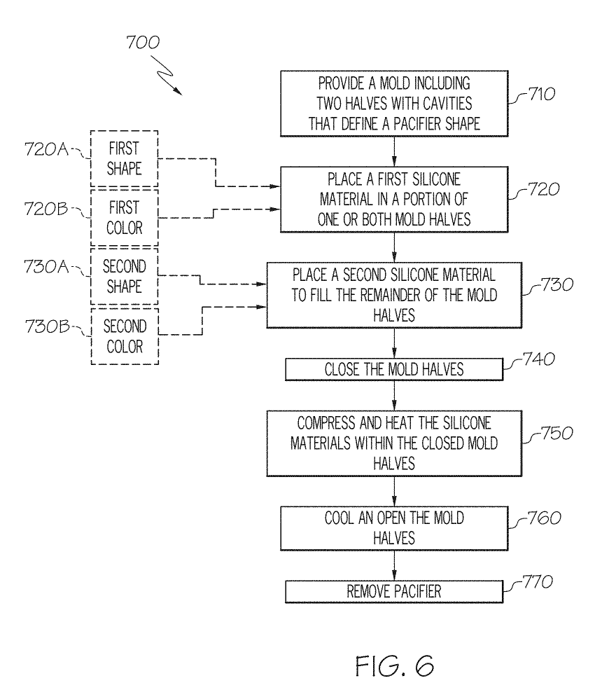

Referring next to FIG. 6, by using compression molding, the two mold cavities 515, 525 of the molding device used for the compression mold 500 may be made to come together to form the unitary pacifier 100 with two separate grades of silicone, thereby promoting the increased hygienic properties of medical grade silicone in regions that require it along with the flexibility to include aesthetically-pleasing deigns in regions that permit it. In one embodiment, varying mechanical or structural properties may be tailored into the silicone materials. For example, in one form, the ShoreA hardness can be adjusted to provide suitable rigidity or flexibility, depending on the need. Similar adjustments may be made to provide suitable yield stress or modulus of elasticity values, again, depending on the design needs. Initially, the compression molding 700 of one or more of pacifiers 100, 200, 300 and 400 starts with providing a mold 500 in step 710. In such case, the mold 500 includes its first and second platens 510, 520 with corresponding cavities 515, 525. In steps 720 and 730, the first and second silicone materials are placed into their respective places within the cavities 515, 525. In one particular form, the first silicone material may be the one exhibiting solid or putty-like qualities such that it may be inserted into the appropriate location of one or both of the cavities 515, 525 (for example, in a region within the cavities 515, 525 that correspond to the nipple portion 104 or its adjacent shield portion 102), an in an optional form, may be cut or otherwise preformed to minimize excess or waste. Likewise, the second silicone material may be subsequently introduced into the portions of the cavities 515, 525 that are not already occupied by the first silicone material. In step 740, after alignment of the cavities 515, 525, the mold 500 is closed. In step 750, compression and heat are applied to the mold 500 in order to cure the pacifier 100. In one form, a hydraulic ram (not shown) may be used to generate sufficient force during the molding process. Excess silicone material may be carried away through overflow grooves (not shown) that are formed in the platens 510, 520. The heat and pressure are maintained until the pacifier 100 is cured. In step 760, the mold 500 is cooled, after which the platens 510 and 520 are opened, while in step 770, the pacifier 100 is removed.

It is noted that terms like “preferably”, “generally” and “typically” are not utilized herein to limit the scope of the claims or to imply that certain features are critical, essential, or even important to the structure or function of the claims. Rather, these terms are merely intended to highlight alternative or additional features that may or may not be utilized in a particular embodiment of the present disclosure. Likewise, for the purposes of describing and defining the present disclosure, it is noted that the terms “substantially” and “approximately” and their variants are utilized herein to represent the inherent degree of uncertainty that may be attributed to any quantitative comparison, value, measurement or other representation, as well as to represent the degree by which a quantitative representation may vary without resulting in a change in the basic function of the subject matter at issue.

While certain representative embodiments and details have been shown for purposes of illustrating the present disclosure, it will be apparent to those skilled in the art that various changes may be made without departing from the scope of such disclosure, which is defined in the appended claims.

What is claimed is:

1. A pacifier comprising:
a shield portion; and
a nipple portion integrally formed with the shield portion, wherein the nipple portion and at least some of the shield portion are made from at least one of a different grade of silicone or a different color of silicone from one another, and further wherein the nipple portion and the shield nipple portion are devoid of any printed indicia.

2. The pacifier of claim 1, wherein neither of the shield portion nor the nipple portion are overmolded relative to one another.

3. The pacifier of claim 2, wherein the nipple portion and the at least some of the shield portion comprises a medical-grade silicone while a remainder of the shield portion comprises a food-grade silicone.

4. The pacifier of claim 3, wherein the food-grade silicone is made from a different color than the medical-grade silicone.

5. The pacifier of claim 1, wherein the nipple portion is shaped such that a distal end defines a larger lateral profile than a proximal end.

6. The pacifier of claim 1, wherein a profile defined by the pacifier comprises one of a cupcake, an ice cream cone, a flower and a box of popcorn.

7. The pacifier of claim 1, wherein the shield portion defines a cantilevered handle extending therefrom.

8. The pacifier of claim 2, wherein both the nipple portion and the shield portion comprise a food-grade silicone where the shield portion comprises a different color than the nipple portion.

9. A method of making a pacifier, the method comprising:
introducing a first silicone material into a compression mold that is shaped to define the pacifier that comprises at least a shield portion and a nipple portion;
introducing a second silicone material into the compression mold, wherein the second silicone material is made from at least one of a different grade of silicone or a different color of silicone from that of the first silicone material; and
compressing the first and second silicone materials such that the nipple portion is integrally formed with the shield portion, wherein both the nipple portion and the shield portion are devoid of any printed indicia.

10. The method of claim 9, wherein the compression mold comprises a pair of mold platens that are configured to cooperate with one another to define an interior region that is shaped to define the pacifier, wherein a first of the pair of mold platens defines at least a majority of the nipple portion and a surface of the shield portion that is facingly adjacent the nipple portion, and further wherein a second of the pair of mold platens defines at least a surface of the shield portion that is facingly opposite the nipple portion.

11. The method of claim 10, wherein the first silicone material comprises a medical-grade silicone and the second silicone material comprises a food-grade silicone.

12. The method of claim 11, wherein the medical-grade silicone is of a different color from the food-grade silicone.

13. The method of claim 9, wherein no injection molding is used to make the pacifier.

14. The method of claim 9, wherein the shape of the pacifier is such that at least one undercut is defined in compression mold.

15. The method of claim 9, wherein the introduction of at least one of the first and second silicone materials takes place while the at least one of the first and second silicone materials is in solid or putty form.

16. A pacifier comprising a shield portion and a nipple portion that define a one-piece unitary structure that is prepared by a process comprising:
(a) using a compression mold to define through cavities formed in the surface thereof an exterior shape of the pacifier;
(b) introducing a first silicone material into the compression mold;
(c) introducing a second silicone material into the compression mold, wherein the second silicone material is made from at least one of a different grade of silicone or a different color of silicone from that of the first silicone material; and
(d) compressing the first and second silicone materials such that the nipple portion is integrally formed with the shield portion, wherein both the nipple portion and the shield portion are devoid of any printed indicia.

17. The pacifier of claim 16, wherein the process further comprises removing the integrally formed pacifier from the compression mold wherein the nipple portion defines an undercut in the compression mold.

18. The pacifier of claim 17, wherein the process further comprises using no inserts adjacent the undercut in the compression mold.

19. The pacifier of claim 18, wherein the pacifier defines at least one of (a) a fanciful design and (b) a combination of colors.
